(19) United States
(12) Patent Application Publication
(10) Pub. No.: US 2009/0168170 A1
(43) Pub. Date: Jul. 2, 2009

(54) WIRE GRID POLARIZER AND METHOD FOR FABRICATING THE SAME

(75) Inventors: CHEN YANG HUANG, HSINCHU COUNTY (TW); CHENG WEI CHU, TAIPEI COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: INDUSTRIAL TECHNOLOGY RESEARCH INSTITUTE, HSINCHU (TW)

(21) Appl. No.: 12/188,704

(22) Filed: Aug. 8, 2008

(30) Foreign Application Priority Data
Dec. 28, 2007 (TW) 096150695

(51) Int. Cl. G02B 5/30; B29D 11/00

(52) U.S. Cl. 359/486; 216/24; 359/483

(57) ABSTRACT

A metal wire grid polarizer comprises a transparent substrate, a transparent film structure and a plurality of metal wires. The transparent film structure, in a planar waveform shape, is formed on the surface of the transparent substrate and has a plurality of adjacent grid lines of triangular cross-sections. The grid lines are arranged at a period and basically abutted against one another. The metal wires are formed separately and arranged at the same period of the transparent film structure in a direction orthogonal to the grid line direction.

### BACKGROUND OF THE INVENTION

1. Field of the Invention

The present invention relates to a wire grid polarizer, and more particularly, to a wire grid polarizer having a transparent film structure in a planar waveform shape.

2. Description of the Related Art

Conventionally, there have been various types of polarizers, which transmit only linearly polarized light with a specific polarization component out of two linearly polarized lights being orthogonal to each other and absorbs or reflects the other polarization component. Recently, a type of polarizer shown in FIG. 1 as a wire grid polarizer has drawn attention as the only polarizer type that exhibits such excellent properties that it can be used not only as a transmission type but also as a reflection type. The wire grid polarizer in FIG. 1 comprises a light-transmitting substrate 101 and a metal wire grating 103 disposed on the light-transmitting substrate including a plurality of separated metal wires 102 arranged at a certain period P.

The wire grid polarizer disclosed in U.S. Pat. No. 6,122,103 is a type of semiconductor polarizer, which includes a plurality of nanometer scale metal wires fabricated on a light-transmitting substrate using semiconductor manufacturing technology. However, this manufacturing technology is expensive, and therefore the cost of devices fabricated by this technology is high. Moreover, although nanometer scale features can be easily fabricated by the present semiconductor technology, the manufacturing processes are complex, and the nanometer scale manufacturing technology is not easily applied to processing a large area.

U.S. Pat. No. 7,046,772 discloses several types of wire grid polarizers. The metal wire in the wire grating structure of each polarizer has a different taper shape in cross-section. Numerical simulation demonstrates that the wire grid polarizers disclosed in U.S. Pat. No. 7,046,772 provide better extinction ratio performance than any of the prior art polarizers. However, the method for manufacturing the disclosed wire grid polarizers is not provided in this patent.

Japanese Patent Publication Nos. 11237507 and 2000-171632 pertain to a staking of corrugated multi-layers of Si and SiO₂ fabricated and shaped by sputter deposition and sputter etching. The two patents provide a method for manufacturing a unit cell of photonic crystals using sputter deposition and sputter etching methods. In these two patents, Si and SiO₂ are the only two processed materials, and no processing technique for other materials, especially metals, is taught.

The above-mentioned technique for fabricating a staking of corrugated multi-layers by sputter deposition and sputter etching is suitable for large area processing. It can be used to fabricate nanometer scale features, and the cost is low. However, from the above discussion there are no methods, especially for the structures disclosed in U.S. Pat. No. 7,046,772, being developed for manufacturing a low cost, nanoscale polarizer.

### SUMMARY OF THE INVENTION

According to one aspect of the present invention, a wire grid polarizer comprises a transparent substrate, a transparent film structure, and a plurality of metal wires. The transparent substrate includes a surface. The transparent film structure formed on the surface comprises a plurality of adjacent grid lines, which abut against each another and have triangular lateral cross-sections, wherein the grid lines are arranged at a spatial period and form a waveform surface. The metal wires formed on the waveform surface are spaced apart in parallel along a direction orthogonal to the direction of the grid line at the spatial period.

According to another aspect of the present invention, a wire grid polarizer comprises a transparent substrate and a plurality of metal wires. The transparent substrate includes a surface on which a plurality of adjacent grid lines, abutted against one another, having triangular lateral cross-sections are formed at a spatial period. The metal wires are disposed above the grid lines, spaced apart in parallel along a direction orthogonal to the direction of the grid line, at the spatial period.

The present invention proposes a method for fabricating a wire grid polarizer. A transparent substrate is initially provided. The transparent substrate comprises a transparent film structure, which is formed on a surface of the transparent substrate and comprises a plurality of adjacent grid lines, abutted against one another, having triangular lateral cross-sections, wherein the grid lines are arranged at a spatial period and form a waveform surface. Thereafter, a metal film is formed on the transparent film structure by a deposition method. Finally, portions of the metal film are removed by a plasma etching method so as to form a plurality of spaced-apart metal wires.

### BRIEF DESCRIPTION OF THE DRAWINGS

The invention will be described according to the appended drawings in which:

FIG. 1 is a lateral cross-sectional view of a prior art wire grid polarizer;

FIG. 2 is a perspective view of a wire grid polarizer according to one embodiment of the present invention;

FIG. 3A is a view of the wire grid polarizer of FIG. 2 along lateral cross section 3A-3A according to one embodiment of the present invention;

FIG. 3B is a lateral cross-sectional view of a wire grid polarizer having metal wires formed on the convex surface according to one embodiment of the present invention;

FIG. 4A is a lateral cross-sectional view of a wire grid polarizer having metal wires formed on the concave surface according to another embodiment of the present invention;

FIG. 4B is a lateral cross-sectional view of a wire grid polarizer having metal wires formed on the convex surface according to another embodiment of the present invention;

FIG. 5 is a graph showing the P/S ratio of the wire grid polarizer of FIG. 3A in the embodiment of the wire grid polarizer according to the present invention;

FIG. 6A-6D are lateral cross-sectional views of a wire grid polarizer according to one embodiment of the present invention in steps of a method for fabricating the wire grid polarizer;

FIG. 7 shows a system for fabricating a wire grid polarizer according to one embodiment of the present invention; and

FIG. 8 shows a system for fabricating a wire grid polarizer according to another embodiment of the present invention.

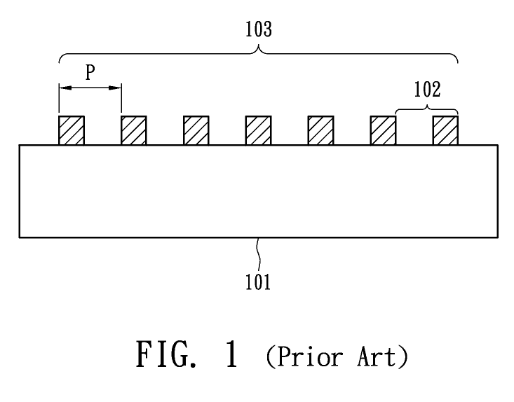

### PREFERRED EMBODIMENT OF THE PRESENT INVENTION

The present invention proposes a fabrication method for manufacturing a large-scale wire grid polarizer composed of metal and dielectric material using sputter deposition and sputter etching technique.

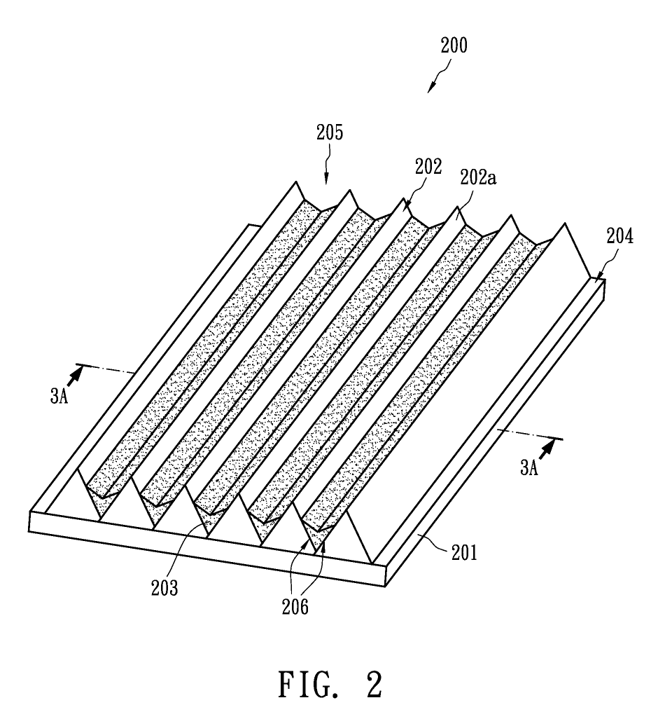

FIG. 2 is a perspective view of a wire grid polarizer according to one embodiment of the present invention. A wire grid polarizer 200 proposed by the present invention comprises a transparent substrate 201 and a transparent film structure 202 disposed on a surface 204 of the transparent substrate 201, wherein the transparent film structure 202 having a waveform surface 205 comprises a plurality of adjacent grid lines 202a, which have triangular cross-sections, are arranged at a period, and abut against one another. The grid lines 202a have substantially the same cross-sectional areas, and thus the transparent film structure 202 has a spatial period. Spaced-apart metal wires 203 are substantially in parallel and formed on the concave surface 206 of the transparent film structure 202. In principal, the direction of the metal wires 203 is orthogonal to the grid line direction, and the metal wires 203 have the same spatial period as the transparent film structure 202. The combination of the transparent film structure 202 and the metal wires 203 constitutes a wire grid polarizer 200, which transmits only linearly polarized light with a specific polarization component out of two linearly polarized lights being orthogonal to each other and absorbs or reflects the other polarization component.

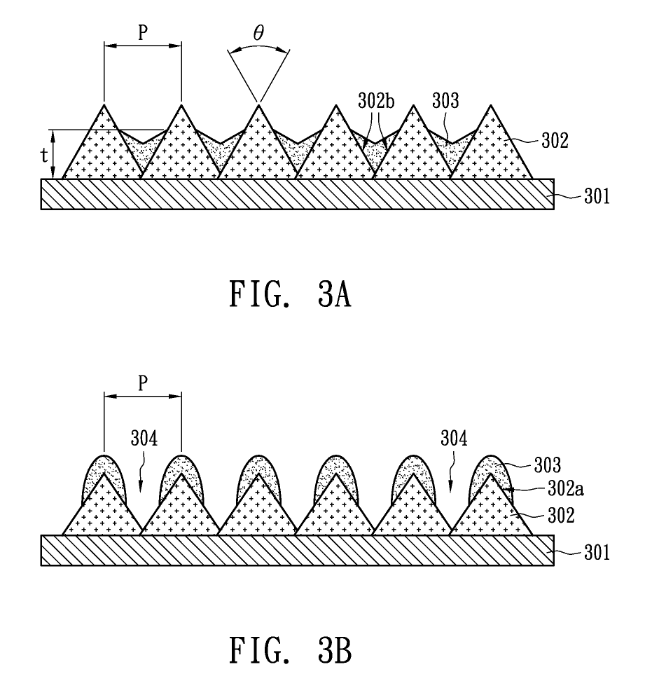

FIG. 3A is a view of the wire grid polarizer of FIG. 2 along lateral cross section 3A-3A according to one embodiment of the present invention. A transparent film structure 302 formed on a transparent substrate 301 has a spatial period, P, i.e., the distance between any of two adjacent peaks or valleys is equal. Pluralities of metal wires 303, with the same periodicity P, are formed on the concave surfaces 302b of the transparent film structure 302. The transparent film structure 302 can be fabricated by directly reprocessing a transparent substrate 301 or formed while the transparent substrate 301 is being processed. The forming method of the transparent film structure 302 depends on the transparent substrate material and the processing method thereof. The transparent film structure 302 can also be formed of dielectrical materials such as tantalum pentoxide (Ta₂O₅), titanium dioxide (TiO₂), niobium pentoxide (Nb₂O₅), silicon dioxide (SiO₂) silicon nitride (SiNx) and magnesium fluoride (MgF₂) by sputter deposition and sputter etching processes. The metal wires 303 are made of metal comprising gold, aluminum, silver and copper. Factors such as incident light wavelength, periodicity of metal wires, wire width and wire thickness primarily determine the performance of a wire grid polarizer. Therefore, the peak angle, θ, the periodicity of metal wires or the wire thickness can be adjusted for different light wavelength applications.

FIG. 3B is a lateral cross-sectional view of a wire grid polarizer having metal wires formed on the convex surface according to one embodiment of the present invention. In this embodiment, the metal wires, with the same periodicity, P, are formed separately on the corresponding convex surfaces 302a of the transparent film structure 302. The metal wires and the transparent portions 304 therebetween constitute a polarizing grating structure.

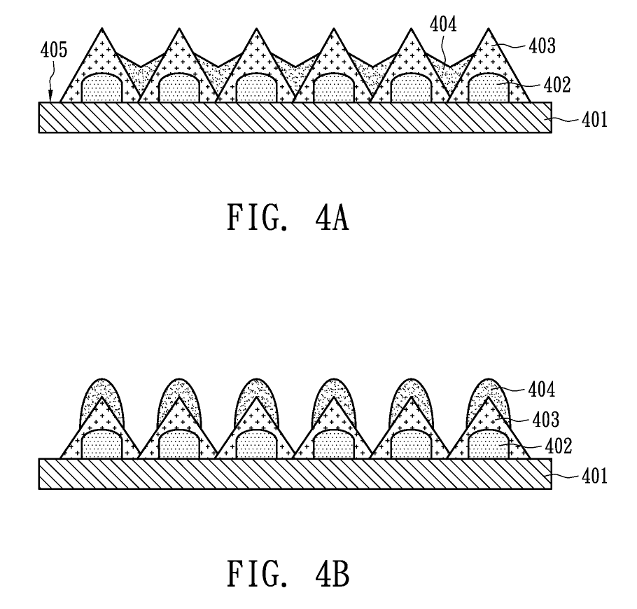

FIG. 4A is a lateral cross-sectional view of a wire grid polarizer having metal wires formed on the concave surface according to another embodiment of the present invention, and FIG. 4B is a lateral cross-sectional view of a wire grid polarizer having metal wires formed on the convex surface according to another embodiment of the present invention. Referring primarily to FIG. 4A and 4B, but also referring to FIG. 3A and 3B, the difference between FIG. 3A and FIG. 4A or FIG. 3B and FIG. 4B is that a transparent film structure 403 is formed on the light-transmitting periodic convex structure 402, which is on the surface 405 of a transparent substrate 401. A lithographic technique, for example photolithography, interference lithography, nano-imprinting and micro-contact, can be used to fabricate the periodic convex structure 402. After the periodic convex structure 402 is formed, the transparent film structure 403 and the metal wires are then formed in sequence.

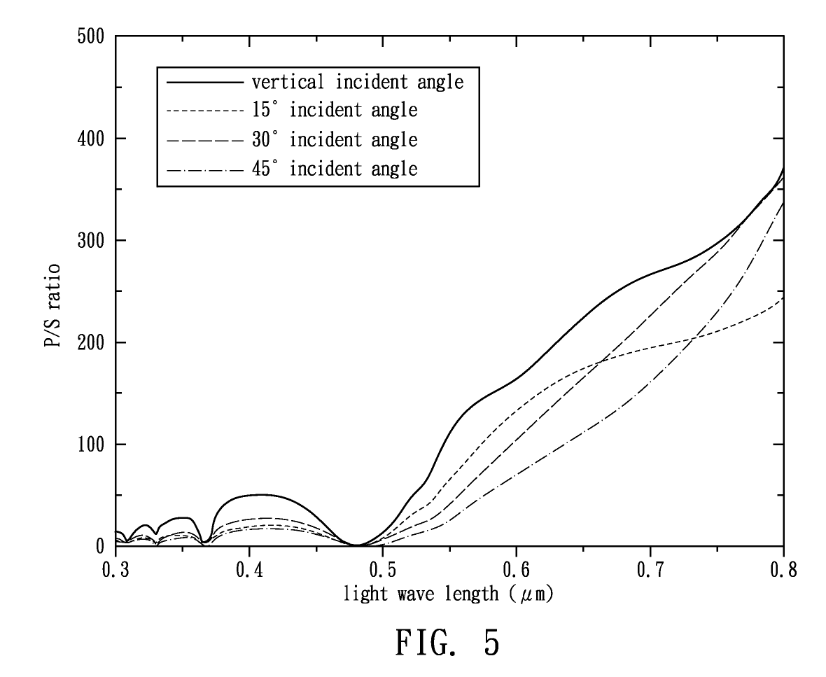

FIG. 5 is a graph showing the P/S ratio of the wire grid polarizer of FIG. 3A in the embodiment of the wire grid polarizer according to the present invention. The P/S ratio of the two polarized lights of p-polarized and s-polarized light, which are orthogonal to each other, were calculated on the wire grid polarizer shown in FIG. 3A by employing the finite difference time domain method. The simulation was carried out at a light incident angle of 45° to the vertical. As illustrated in FIG. 5, when the light wavelength becomes larger, the P/S ratio is higher regardless of the light incident angle, and the simulated results also show that the wire grid polarizer of the present invention results in good and competitive performance.

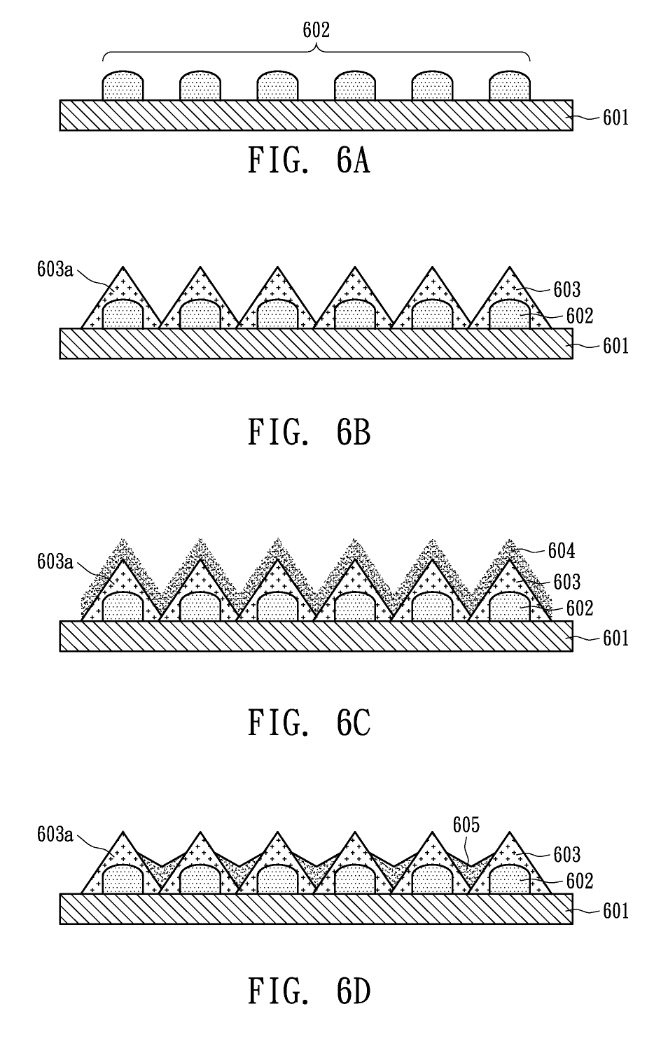

FIG. 6A-6D are lateral cross-sectional views of a wire grid polarizer according to one embodiment of the present invention in steps of a method for fabricating the wire grid polarizer. A light-transmitting periodic convex structure 602 as shown in FIG. 6A is first formed on a transparent substrate 601 using a lithographic technique comprising photolithography, interference lithography, nano-imprinting and micro-contact techniques. Next, an oxide layer is deposited on the periodic convex structure 602 by sputtering, and then is sputter-etched so as to form a transparent waveform-shape film structure 603, which comprises a plurality of grid lines 603a, adjacent to one another, with triangular lateral cross-sections, wherein any two adjacent grid lines abut each other as illustrated in FIG. 6B. To adjust the process parameters, for example sputter etching rate or speed and sputter etch angle, the sputter etching process can make the concave surface of the transparent film structure 603 have a faster etching rate than the convex surface, and then the transparent film structure 603 can be obtained after a processing time. Thereafter, a metal film 604 is sputtered onto the transparent film structure 603 as shown in FIG. 6C. Finally, a plasma-etching apparatus is used to modify the metal film 604. To adjust the process parameters, for example sputter etching rate or speed and sputter etch angle, the sputter etching process can make the convex surface of the metal film 604 have a faster etching rate than the metal film 604 deposited on the concave surface, and then the grid lines 605, as shown in FIG. 6D, can be obtained after a processing time; however to adjust the process parameters properly makes the concave surface of the metal film 604 have a faster etching rate than the metal film 604 deposited on the convex surface, and then the grid lines 303, as shown in FIG. 3B, can be obtained after a processing time. The above mentioned film deposition method may comprise an ion beam sputtering (IBS) method, a magnetron sputtering method, an evaporation method and a chemical vapor deposition (CVD) method; however, the plasma etching method may comprise a DC (Direct Current) plasma etching method, an RF (Radio Frequency) plasma method, an ECR (electron cyclotron resonance) plasma method and an ion bombardment method.

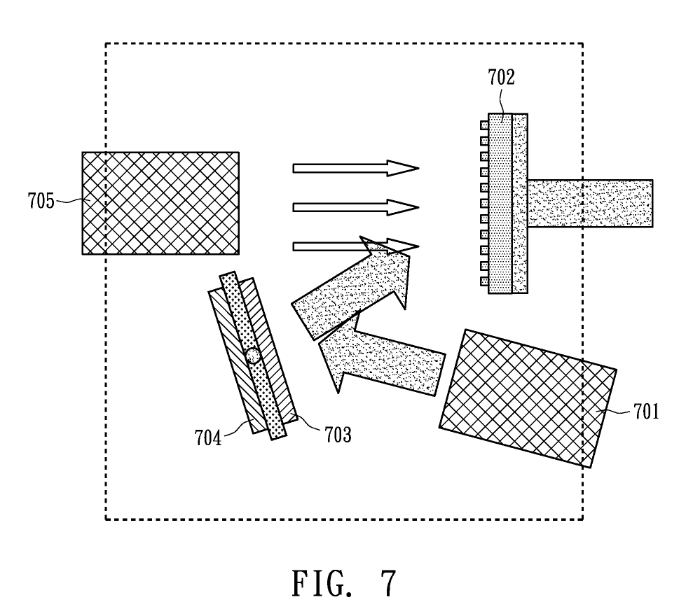

FIG. 7 shows a system for fabricating a wire grid polarizer according to one embodiment of the present invention. The system includes an ion beam sputtering technique and a physical etching technique. The system deposits a film on the periodic convex structure of a substrate 702 with a plasma ion beam generated by an ion source 701 using metal targets 703 or dielectric targets 704. Due to the shielding effect, the deposition rate will decrease as the incident beam angle increases. In this system there is another ion source 705 for an etching process at lower ion energy operation. The etch rate of the ion source 705 increases as the incident beam angle increases according to the etch rate characteristics of the ion source 705, but at a certain angle, the etch rate drops abruptly. By controlling the deposition rate and the etch rate so as to make the film deposit more at some places and etch more at the other places, the waveform profile of a film can be fabricated accurately.

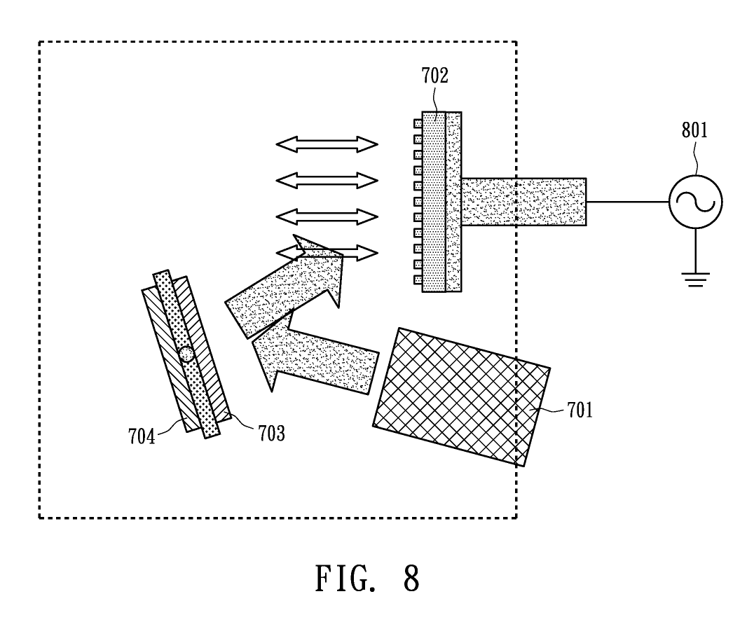

FIG. 8 shows a system for fabricating a wire grid polarizer according to another embodiment of the present invention. A single ion beam sputtering apparatus is equipped with an RF bias power supply 801 for etching. While the ion source 701 bombards targets 703 or 704 during deposition, the RF bias power supply 801 generates the plasma for the etching process. By the combination of two techniques at a location, a waveform structure can be precisely fabricated on a substrate.

The above-described embodiments of the present invention are intended to be illustrative only. Numerous alternative embodiments may be devised by persons skilled in the art without departing from the scope of the following claims.

What is claimed is:

1. A wire grid polarizer, comprising:
a transparent substrate including a surface;
a transparent film structure formed on the surface, the transparent film structure comprising a plurality of immediately adjacent grid lines, wherein each of the grid lines has a triangular lateral cross-section, and the grid lines are arranged at a substantially spatial period and form a waveform surface; and
a plurality of metal wires formed on the waveform surface, spaced apart in parallel along a direction orthogonal to the direction of the grid line at the spatial period.

2. The wire grid polarizer of claim 1, wherein a light-transmitting periodic convex structure is formed on the surface of the transparent substrate.

3. The wire grid polarizer of claim 2, wherein the transparent film structure is formed on the periodic convex structure.

4. The wire grid polarizer of claim 1, wherein the transparent film structure is made of Ta₂O₅, TiO₂, Nb₂O₅, SiO₂, SiNₓ and MgF₂.

5. The wire grid polarizer of claim 1, wherein the metal wires are formed on concave surfaces or convex surfaces of the transparent film structure.

6. The wire grid polarizer of claim 1, wherein the metal wires are made of gold, aluminum, silver or copper.

7. A wire grid polarizer, comprising:
a transparent substrate including a surface on which a plurality of immediately adjacent grid lines having triangular lateral cross-sections are formed at a spatial period; and
a plurality of metal wires disposed above the grid lines, spaced apart in parallel along a direction orthogonal to the direction of the grid line at the spatial period.

8. The wire grid polarizer of claim 7, wherein the metal wire is formed on a convex surface of the corresponding grid line or on a concave surface between the two adjacent grid lines.

9. The wire grid polarizer of claim 7, wherein the metal wires are made of gold, aluminum, silver or copper.

10. A method for fabricating a wire grid polarizer, comprising the steps of:
providing a transparent substrate comprising a transparent film structure, the transparent film structure comprising a plurality of immediately adjacent grid lines, the grid lines having triangular lateral cross-sections, wherein the grid lines are arranged at a spatial period and form a waveform surface;
forming a metal film on the transparent film structure by a deposition method; and
removing portions of the metal film by a plasma etching method so as to form a plurality of spaced-apart metal wires.

11. The method of claim 10, wherein the providing step further comprises the steps of:
forming a light-transmitting periodic convex structure on the surface by a lithographic technique;
disposing a transparent film on the periodic convex structure; and
removing portions of the transparent film so as to form a plurality of adjacent grid lines, abutted against one another, having triangular lateral cross-sections.

12. The method of claim 10, wherein the removing step further comprises the steps of:
providing the transparent substrate comprising the transparent film structure, wherein the transparent film structure comprises a plurality of immediately adjacent grid lines having triangular lateral cross-sections;
forming the metal film on the transparent film structure; and
removing portions of the metal film so as to form a plurality of spaced-apart metal wires, wherein the metal wires are on a convex surface of the transparent film structure or on a concave surface of the transparent film structure.

13. The method of claim 11, wherein the lithographic technique is photolithography, interference lithography, nano-imprinting and micro-contact.

14. The method of claim 10, wherein the deposition method comprises an ion beam sputtering method, a magnetron sputtering method, an evaporation method and a chemical vapor deposition method.

15. The method of claim 11, wherein the deposition method comprises an ion beam sputtering method, a magnetron sputtering method, an evaporation method and a chemical vapor deposition method.

16. The method of claim 10, wherein the deposition method comprises an ion beam sputtering method, a magnetron sputtering method, an evaporation method and a chemical vapor deposition method.

17. The method of claim 10, wherein the plasma etching method comprises a direct current (DC) plasma etching method, a radio frequency (RF) plasma method, an electron cyclotron resonance (ECR) plasma method and an ion bombardment method.

18. The method of claim 11, wherein the plasma etching method comprises a DC plasma etching method, an RF plasma method, an ECR plasma method and an ion bombardment method.

19. The method of claim 12, wherein the plasma etching method comprises a DC plasma etching method, an RF plasma method, an ECR plasma method and an ion bombardment method.

20. The method of claim 10, wherein the metal wires are made of gold, aluminum, silver or copper.

21. The method of claim 12 wherein the metal wires are made of gold, aluminum, silver or copper.

22. The method of claim 11, wherein the transparent film structure is made of Ta₂O₅, TiO₂, Nb₂O₅, SiO₂, SiNₓ and MgF₂.

23. The method of claim 10, wherein the metal wires are formed on a convex surface of the transparent film structure or on a concave surface of the transparent film structure.
